(19) United States
(12) Patent Application Publication
(10) Pub. No.: US 2018/0081477 A1
(43) Pub. Date: Mar. 22, 2018

(54) HINGED TOUCHPAD

(71) Applicant: Microsoft Technology Licensing, LLC, Redmond, WA (US)

(72) Inventors: Carl E. Picciotto, Bellevue, WA (US); Launnie K.E. Ginn, Kent, WA (US); Aric A. Fitz-Coy, Seattle, WA (US)

(21) Appl. No.: 15/267,503

(22) Filed: Sep. 16, 2016

(51) Int. Cl. G06F 3/041; G06F 3/044; G06F 3/0354; G06F 3/01; G06F 1/16

(52) U.S. Cl. CPC G06F 3/0414; G06F 3/044; G06F 1/1681; G06F 3/0416; G06F 3/016; G06F 3/03547

(57) ABSTRACT

The described technology provides an input apparatus for a computing device, the input apparatus including a touchpad configured to receive a force input, a hinge mechanism along a front edge of the touchpad, and one or more force sensitive elements along a rear edge of the touchpad. In one implementation, the force sensitive elements are piezo discs that also functions as haptic elements for providing a haptic feedback.

### BACKGROUND

Many computer devices take input from a keyboard. For example, a laptop computer has a display pivotably attached to a base comprising a keyboard. In addition to a keyboard, a computer device may also be attached to a mouse, or have a trackball or a touchpad for receiving further input. A touchpad detects touch by a user and converts this to an input signal. For example, a user may be able to control a pointer shown on the display by moving their finger across a surface of the touchpad. Touch sensitive displays are also used by some computer devices, whereby a user is able to input instructions directly to the computer by touching the display.

### SUMMARY

The described technology provides an apparatus for a computing device. The apparatus includes a touchpad configured to receive a force input, a hinge mechanism along a front edge of the touchpad, and one or more force sensitive elements along a rear edge of the touchpad. In one example implementation, the force sensitive elements are piezo discs, which also functions as haptic elements for providing a haptic feedback. In another implementation, a combination of force sensitive elements and haptic elements are configured along the rear edge of the touchpad.

The above presents a simplified summary of the innovation in order to provide a basic understanding of some implementations described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Other implementations are also described and recited herein.

### BRIEF DESCRIPTIONS OF THE DRAWINGS

Examples are illustrated in referenced figures of the drawings. It is intended that the examples and figures disclosed herein are to be considered illustrative rather than restrictive.

FIG. 1 illustrates an example computing system including a hinged touchpad disclosed herein.

FIG. 2 illustrates an alternative example system including the hinged touchpad disclosed herein.

FIG. 3 illustrates an example base for housing the hinged touchpad disclosed herein.

FIG. 4 illustrates an example base for housing the hinged touchpad with force sensitive elements and haptic elements.

FIG. 5 illustrates an example base for housing the hinged touchpad with force sensitive elements and retention pads.

FIG. 6 illustrates additional elements of the example hinged touchpad.

FIG. 7 illustrates operations for configuring a hinged touchpad disclosed herein.

FIG. 8 illustrates a top view of the hinge mechanism used in the hinged touchpad disclosed herein.

FIG. 9 illustrates example top view of a touchpad assembly with a hinge and one more force sensitive elements and haptic elements.

FIG. 10 illustrates an electrical model of an example force sensitive element used in the hinged touchpad disclosed herein.

FIG. 11 illustrates a side view of an example hinged touchpad disclosed herein.

FIG. 12 illustrates an example computing system that may be used to implement the hinged touchpad disclosed herein.

### DETAILED DESCRIPTIONS

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As consumer devices get thinner and thinner to satisfy industrial design and usability goals, mechanical user input devices such as moveable keys and dome switches are being displaced by superflat devices. Such superflat devices may employ different technologies, such as capacitive sensors, force-sensitive technologies such as FSR's (force-sensitive resistors), strain gauges, and piezoelectric or piezoresistive force sensors. These devices typically feature keys and buttons that provide little or no tactile feedback, either passive (e.g. texture or fixed relief) or active (responding to user activation). The result tends to be a compromised user experience: keys and buttons that provide little or no tactile feedback to the user, thereby reducing user confidence, efficiency, and quality of experience.

The disclosed technology provides an input apparatus for a computing device, the input apparatus including a touchpad configured to receive a force input from a user, a hinge mechanism along a front edge of the touchpad, and one or more force sensitive elements along a rear edge of the touchpad. In one example implementation, the haptic elements are piezo discs. The piezo discs also function as haptic elements by providing vibrational feedback to a user via a surface of the touchpad. In one alternative implementation, the touchpad includes a combination of force sensitive elements and haptic elements along the rear edge of the touchpad.

Various implementations disclosed herein use the terms “trackpad,” “touchpad,” “pressure pad,” “force pad,” and “clickpad” interchangeably. A touchpad may generate an output signal in response to force applied to the surface of the touchpad. The level of signal may be a function of the force or pressure applied to the surface. Herein the terms “force” and “pressure” (which represents force applied per unit area) are used interchangeably.

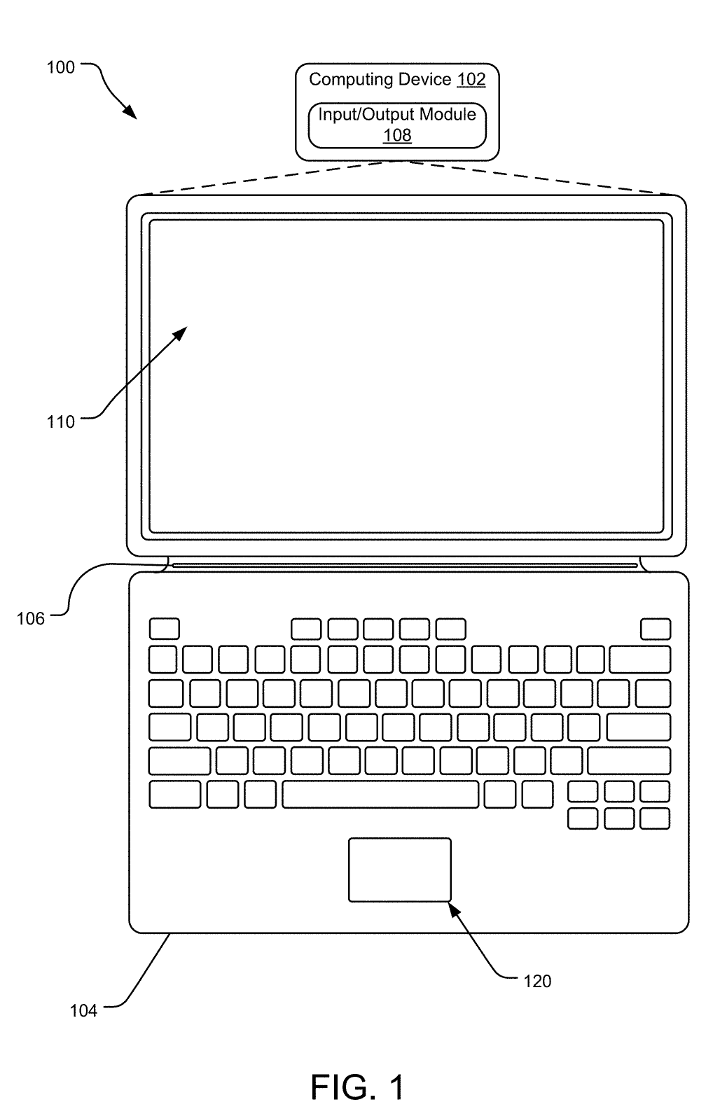

To appreciate the applicability of the various techniques of the present application, attention will now be drawn to one example environment in which these techniques and use of the haptic examples described herein may reside. FIG. 1 is an illustration of an environment 100 in an example implementation that is operable to employ the techniques described herein.

The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer as illustrated, and so on that is configured to be held by one or more hands of a user. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as having an input portion that includes a keyboard having a QWERTY arrangement of keys and track pad although other arrangements of keys are also contemplated. Further, other non-conventional configurations are also contemplated, such as a game controller, configuration to mimic a musical instrument, and so forth. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that implementation is also contemplated. Further, this flexible rotation may be configured to support movement in one or more directions (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

The flexible hinge 106, for instance, may be formed using one or more layers of fabric and include conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on. In one implementation, the input device 104 may include a touchpad 120 that is configured to receive force input from a user and to convert the force input into an electrical signal that may be processed by a processor of the computing device. In one implementation, the touchpad 120 includes a hinge mechanism at a front edge (in FIG. 1, the edge near the keyboard) of the touchpad 120 and various force sensitive elements, such as piezo discs near a rear edge (in FIG. 1, the edge away from the keyboard).

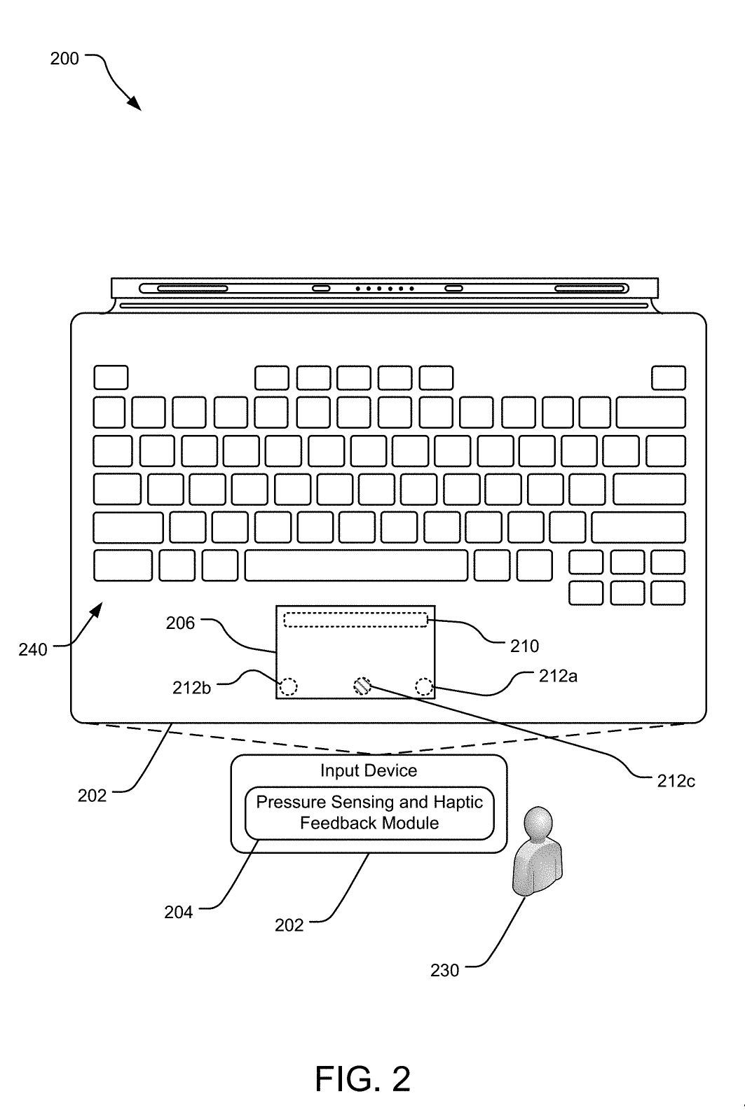

FIG. 2 illustrates an alternative example system 200 including the hinged touchpad disclosed herein. Specifically, FIG. 2 depicts an example implementation 200 of the input device 104 of FIG. 1 in greater detail. Furthermore, the implementation 200 discloses an input device 202 that includes a force sensing and haptic feedback module 204. The pressure sensing and haptic feedback module 204 may be implemented using a touchpad 206.

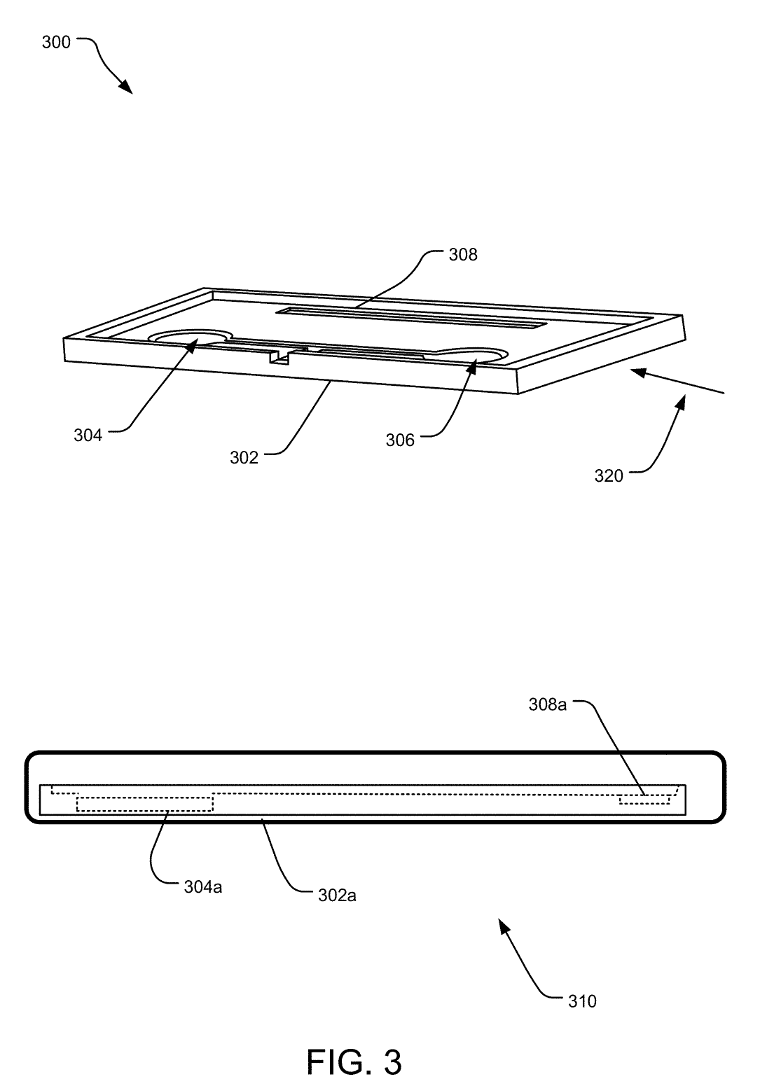

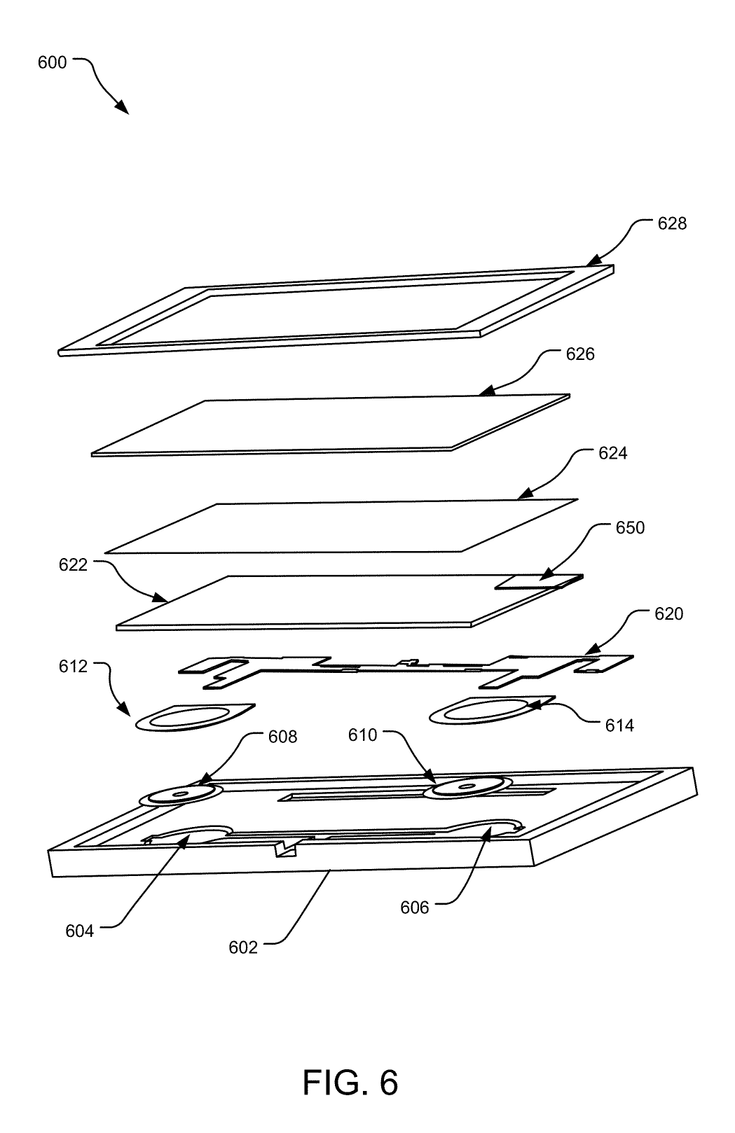

The touchpad 206 may be configured using a hinge mechanism 210 housed within a base (such as the base 302 shown in FIG. 3) underneath a printed circuit board assembly (PCBA) (such as the PCBA 622 shown in FIG. 6). In one implementation, the hinge mechanism 210 may be configured near a front edge of the touchpad 206, wherein such front edge is located away from a user 230 and closer to a keyboard 240.

Furthermore, one or more force sensitive elements 212 may also be used in the configuration of the touchpad 206. In one implementation, the force sensitive elements 212 are piezo discs 212a and 212b that also function as haptic elements to provide vibrational feedback. The piezo discs 212a and 212b are located near a rear edge of touchpad 206, the rear edge being close to the user 230 and away from the keyboard 240. Specifically, the piezo discs 212a and 212b may be located closer to two corners of the touchpad 206 near the rear edge. Alternatively, the force sensitive elements 212 may include only one piezo disc 212c that is located near the center of the rear edge of the touchpad 206.

The touchpad 206 and the hinge 210 are configured such that when the user 230 puts pressure on the touchpad 206, the top surface of the touchpad 206 swings around the hinge mechanism 210 towards the force sensitive elements 212. Such movement of the top surface of the touchpad 206 towards the force sensitive elements 212 may generate pressure on the force sensitive elements 212, resulting in generation of an electrical signal as further described herein.

FIG. 3 illustrates various views 300 of an example base for housing the hinged touchpad disclosed herein. Specifically, FIG. 3 illustrates a three-dimensional view of a base 302 showing mounts 304 and 306 for force sensitive elements such as piezo discs. In one implementation, the mounts 304 and 306 may also house haptic elements together with the force sensitive elements. However, in an alternative implementation, the haptic elements may be configured on other parts of the hinged touchpad. The base 302 also includes mounting strip 308 providing mounting points for a hinge. Furthermore, FIG. 3 also illustrates a side view 310 of the base 302a as viewed from side 320. As seen from the side view 310, the base 302a includes mounts 304a for the force sensitive elements and a mounting strip 308a for mounting a hinge.

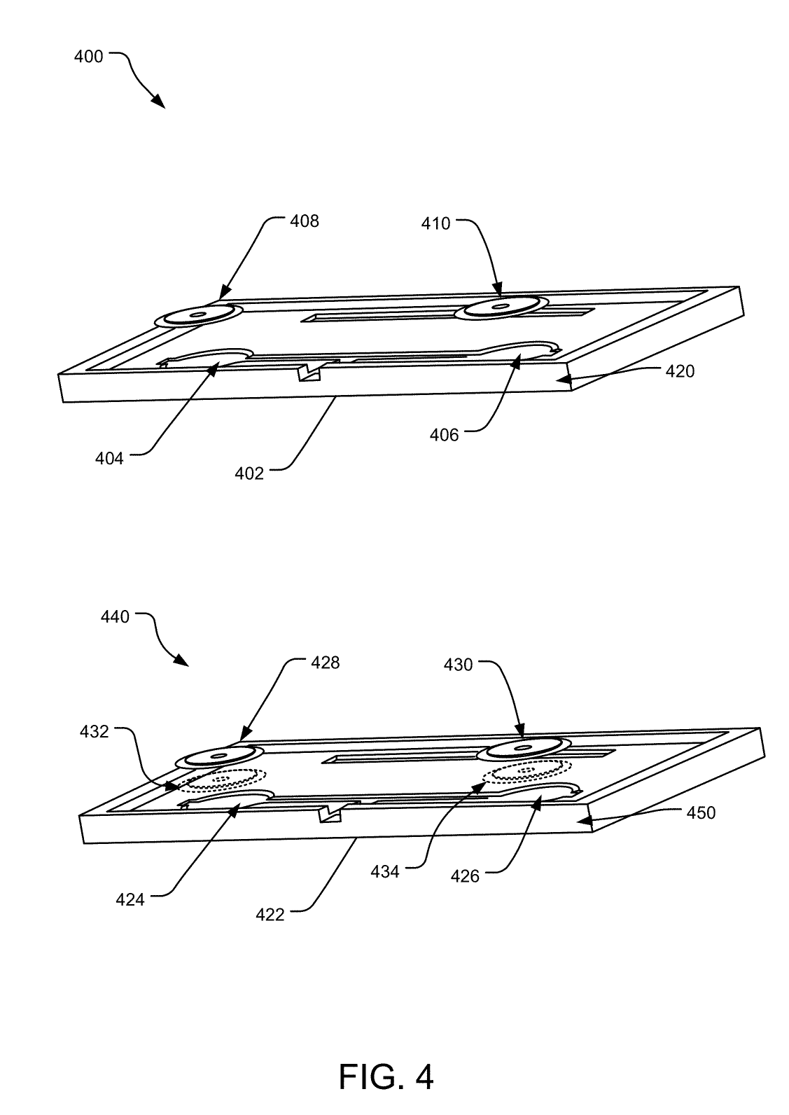

FIG. 4 illustrates a three-dimensional view 400 of an example base 402 housing a hinged touchpad with force sensitive elements. Specifically, the base 402 includes mounts 404 and 406 for mounting piezo discs 408 and 410 as the force sensitive elements. Each of the mounts 404 and 406 are located substantially near corners of a rear edge 420 of the base 402. Note that while the illustrated implementation provides two mounts 404 and 406 housing two piezo discs, in alternative implementation, the base 402 may only include one mount near center of the rear edge 420.

The piezo discs 408 and 410 function not only as force sensitive elements, but they also provide haptic feedback to the user in response to the pressure. Such haptic feedback provided by the piezo discs 408 and 410 may be, for example, in the form of a vibrational feedback. Thus, when a user provides pressure to a surface of a touchpad with the piezo discs 408 and 410, the user may feel vibration on the surface of the touchpad. While in the illustrated implementation, the same elements, namely the piezo discs 408 and 410 function as both force sensitive element as well as the haptic element, in an alternative implementation, separate elements may be used as the force sensitive element and the haptic elements.

FIG. 4 also illustrates such an alternative implementation 440, including an example base 422 housing a hinged touchpad with force sensitive elements and haptic elements. Specifically, the base 422 includes mounts 424 and 426 for mounting force sensitive elements 428 and 430. Furthermore, two haptic elements 432 and 434 are also configured in the mounts 424 and 426 below the force sensitive elements 428 and 430.

The haptic elements 432 and 434 are configured to provide haptic feedback to a user providing pressure on the touchpad. For example, such haptic feedback may be vibration that is generated by the haptic elements 432 and 434 in response to pressure from a user where the vibration is mechanically transmitted to the user via a top surface of the touchpad. Providing such haptic feedback to the user is used as an acknowledgement to the user in response to the force input from the user. In the illustrated implementation, the haptic elements 432 and 434 are also located substantially near corners of a rear edge 450 of the base 402.

The haptic elements 432 and 434 may be for example, high voltage electrostatic devices, electroactive polymers (EAPs), voice coils, electromagnetic mechanisms, eccentric rotating mass (ERM) motor, linear resonant actuator (LRA). In an alternative implementation, the haptic elements may be located at other locations, such as on the PCBA (such as the PCBA 622 of FIG. 6). The haptic elements 432 and 434 enhances user interface of the touchpad.

While the illustrated implementation provides two mounts 424 and 426 housing the force sensitive elements 428 and 430 as well as the haptic elements 432 and 434, in an alternative implementation, the base 420 may only include one mount near the center of the rear edge 450 for housing the force sensitive elements 428 and 430 as well as the haptic elements 432 and 434.

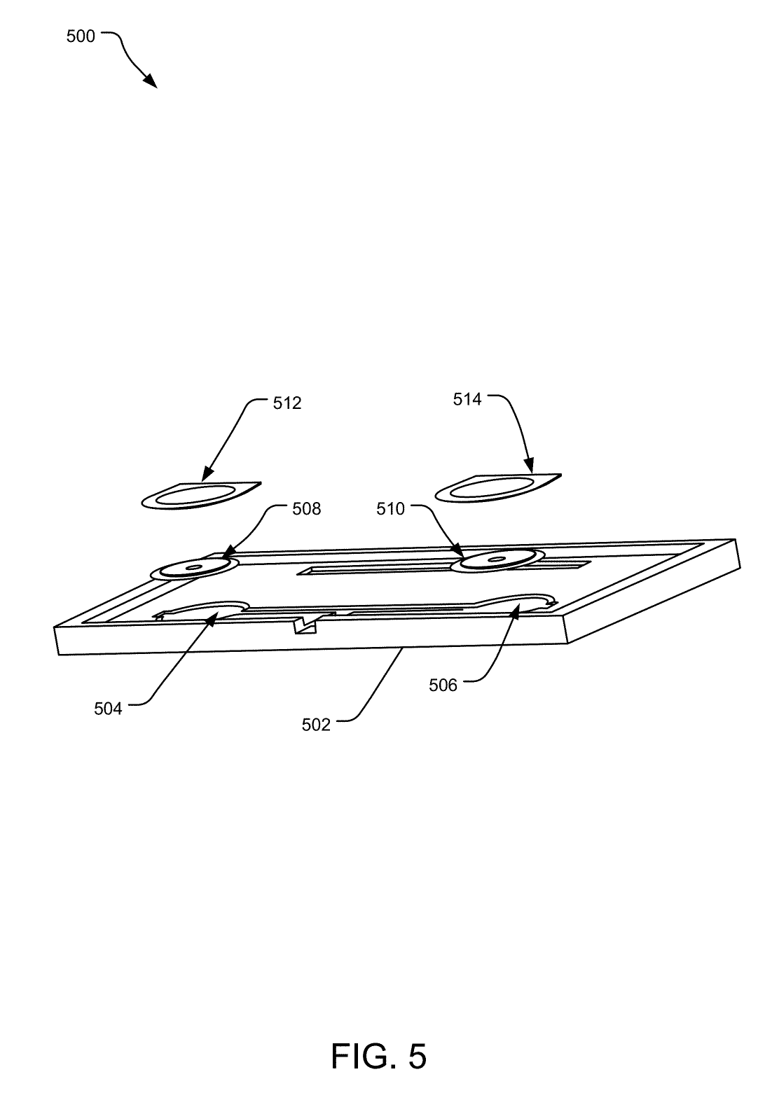

FIG. 5 illustrates a three-dimensional view 500 of an example base 502 housing a hinged touchpad with force sensitive elements. The example base 502 is illustrated to have mounts 504 and 506 for mounting force sensitive elements, such as piezo discs 508 and 510. Furthermore, the mounts 504 and 506 may also house the retention pads 512 and 514 on top of the piezo discs 508 and 510. In one implementation, the retention pads 512 and 514 may be made of Mylar film. Alternatively, the retention pads 512 and 514 may be made of other material providing water and/or a moisture barrier so that the piezo discs 508 and 510 are protected from moisture when a computing device implementing the touchpad is in use.

FIG. 6 illustrates a three-dimensional view of an assembly of components 600 of the example hinged touchpad. Specifically, the assembly of components 600 includes a base 602 for mounting force sensitive elements and for mounting a hinge. The force sensitive elements may be for example, piezo discs 608 and 610 that may be mounted on mounts 604 and 606 located near a rear edge of the base 602. A hinge 620 may be mounted near a front edge of the base 602. Retention pads 612 and 614 may used to protect the force sensitive elements 608 and 610. The assembly of components 600 also includes a printed circuit board assembly (PCBA) 622 that contains various electronic components and circuitry to collect and process signals generated by the force sensitive elements 608 and 610.

In one implementation, the PCBA 622 may also include capacitance sensor (also referred to as “capsense”) elements that may be used to sense movement of a user's finger on the touchpad. The assembly of components also includes a glass adhesive surface 624 that may be used to attach a glass surface 626 to the PCBA 622. The glass adhesive surface 624 may be force sensitive adhesive that mechanically attaches the glass surface 626 to the PCBA 622 such that pressure on the glass surface 626 is mechanically conveyed to the PCBA 622. In such an implementation, the movements of a user's fingers may be sensed by the capsense components of the PCBA 622 so that the position of the user's finger can be used to determine one or more inputs.

Furthermore, in an alternative implementation, the PCBA 622 may also include touch sensing elements to sense the position of a tip of a digital pen in close proximity to the glass surface 626 and movement of the tip of the digital pen over the glass surface 626 to generate one or more inputs for a computing device. A cover 628 may be provided on top of the glass surface 626 to protect the glass surface 626 from various elements such as heat, moisture, etc. The PCBA 622 may also include a haptic element 650 mounted thereon. Such a haptic element 650 may be implemented using, for example, high voltage electrostatic devices, electroactive polymers (EAPs), voice coils, electromagnetic mechanisms, eccentric rotating mass (ERM) motor, linear resonant actuator (LRA).

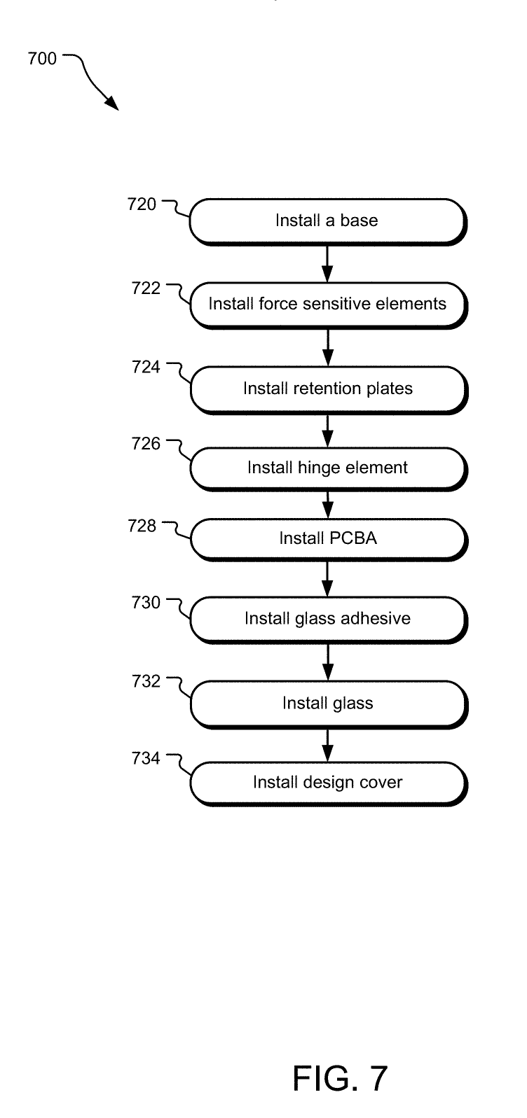

FIG. 7 illustrates operations 700 for configuring a hinged touchpad disclosed herein. For example, the operations 700 may be performed to form a touchpad on a computing device. An operation 720 installs a base in the computing device, such as a laptop. In one implementation, the base includes one or more mounts for mounting force sensitive elements, such as piezo discs thereon. For example, the base may have one mount at the center along a rear edge of the touchpad, two mounts along two corners of the rear edge of the touchpad, etc. The base may also include mounts for a hinge element. An operation 722 installs the force sensitive elements such as the piezo discs onto the mounts in the base.

An operation 724 installs retention plates on top of the force sensitive elements. For example, such retention plates may be made of a material that is water and moisture proof, such as Mylar. An operation 726 installs a hinge element. For example, the hinge element may be installed such a way that a top edge of the hinge is substantially aligned with a front edge of the touchpad. An operation 728 installs a PCBA where such PCBA may include one or more components that collects and processes outputs generated by force sensitive elements. In one implantation, the PCBA may also include capacitive sensors that sense the touch of a user's finger or the touch of a digital pen tip to generate an electrical signal.

An operation 730 installs a glass adhesive surface on top of the PCBA. In one implementation, the glass adhesive surface may be force sensitive adhesive such that it mechanically mates a glass surface to the PCBA to transfer mechanical movement of a glass surface or a part of the glass surface to the PCBA. An operation 732 installs the glass surface on top of the glass adhesive and an operation 734 installs a design cover on top of the glass surface.

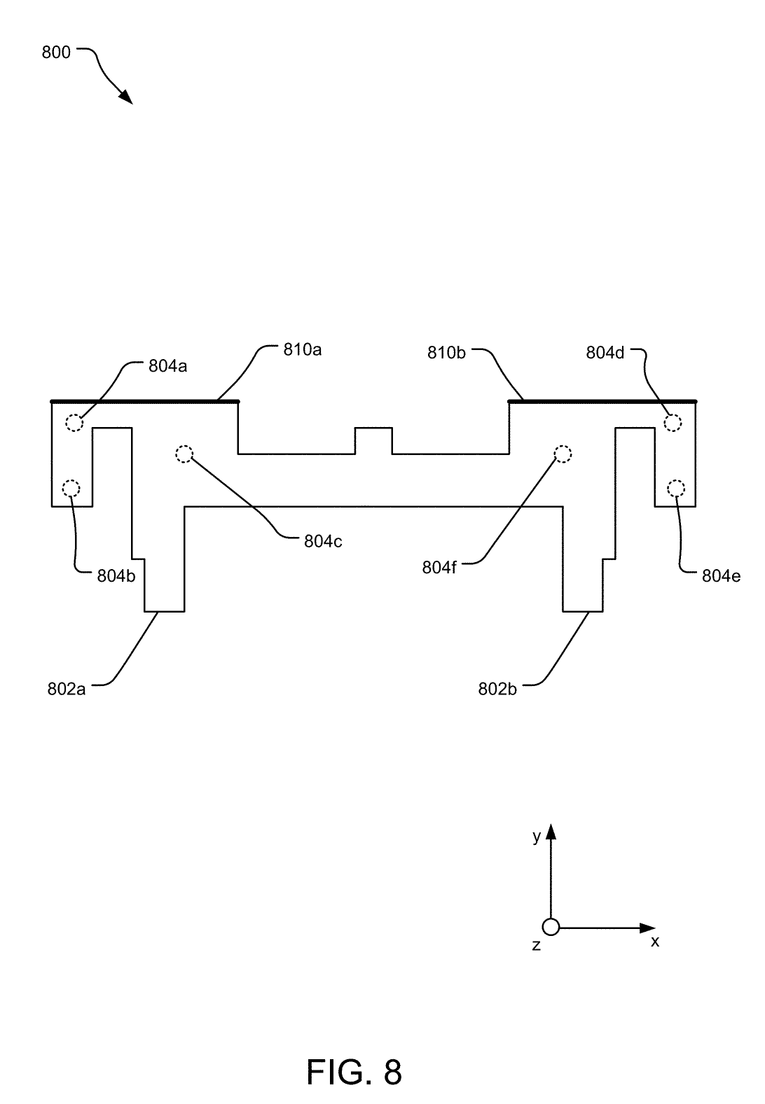

FIG. 8 illustrates a top view of the hinge mechanism 800 used in the hinged touchpad disclosed herein. The hinge mechanism 800 may be made of any material that provides structural strength as well as that is capable of withstanding rotational deflection. For example, fiberglass reinforced plastic (FRP), which has high mechanical strength, light weight, corrosion and temperature resistant properties, thermal insulation, smooth internal surface, easy to form complex shapes, may be used to form the hinge mechanism. Another example of material that may be used to form the spring mechanism may be spring steel, which is used for forming springs. Yet alternatively, material used to form printed circuit boards (PSB), such as flame retardant glass-reinforced epoxy laminate sheets (FR-4) may also be used to form the hinge mechanism 800. The thickness of the hinge mechanism in the z direction may be approximately 1-5 millimeters.

In one implementation, the hinge mechanism 800 may include two arms 802a and 802b protruding in the y-direction away from a top edge 810. The arms 802a and 802b provides additional support to other components of a touchpad, such as a PCBA (622 of FIG. 6) and a glass surface (626 of FIG. 6). The top edge 810 may be movably connected to a hinge mount provided in a base (such as the base 302 shown in FIG. 3). The hinge mechanism 800 also includes a number of alignment holes 804a-804e that are used to align the hinge mechanism 800 along a base (602 of FIG. 6) and a PCBA (622 of FIG. 6).

The hinge mechanism 800 is installed in a base (such as the base 302 shown in FIG. 3) in a manner such that it serves various functions in a touchpad. For example, the hinge mechanism 800 provides mechanical support to various other components of the touchpad, such as a PCBA and a glass surface, that are installed on top of the hinge mechanism 800 along the z-direction. Furthermore, the hinge mechanism 800 is rotatably movable along its top edge 810. Therefore, it transfers mechanical force on one or more components that are installed on top of the hinge mechanism 800 to various components that are installed underneath the hinge mechanism 800. For example, the hinge mechanism 800 transfers mechanical force in the z-direction on a glass surface installed on top of the hinge mechanism 800 to a haptic element such as a piezo disc hat is installed below the hinge mechanism 800 along the z-direction.

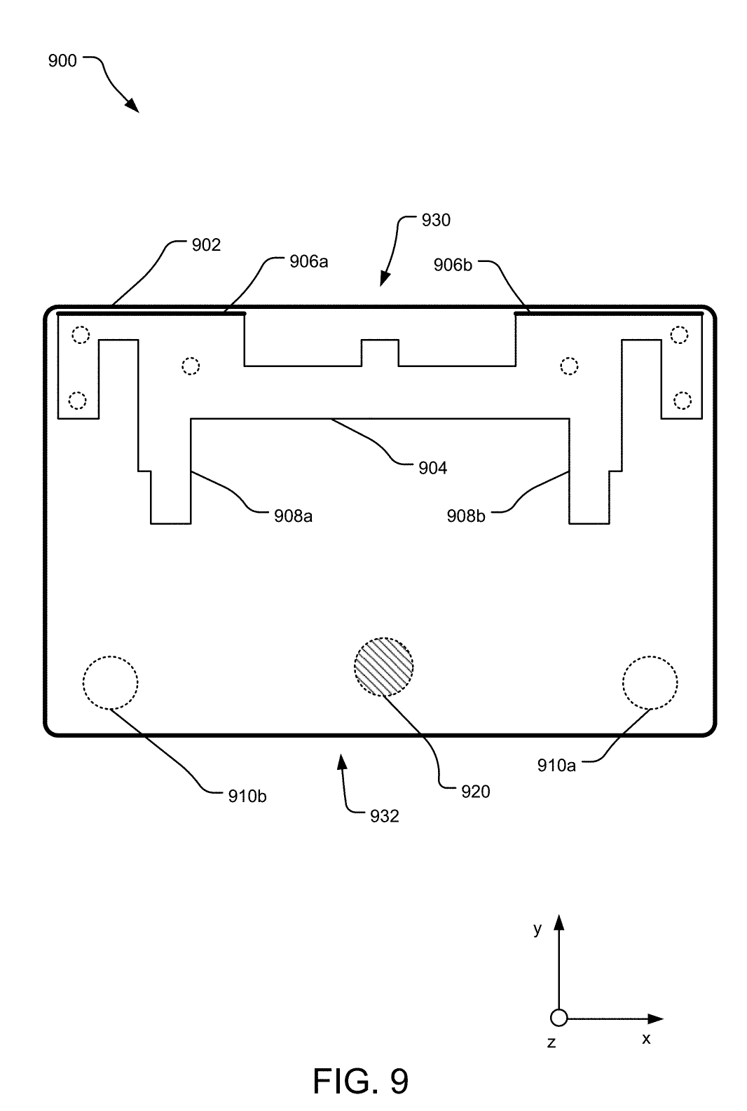

FIG. 9 illustrates an example of the top view 900 of a touchpad 902 with a hinge and one more force sensitive elements. The touchpad 902 may be formed in a computing device such as a laptop. The touchpad 902 includes, among other components, a hinge mechanism 904 and one or more force sensitive elements. Specifically, the hinge mechanism 904 may be installed in the touchpad 902 such that a top edge 906 of the hinge mechanism is near a front edge 930 of the touchpad 902 along a y-direction.

The hinge mechanism 904 may include one or more arms 908 that protrude away from the top edge 906 along the y-direction towards a rear edge 932 of the touchpad 902. The front edge 930 of the touchpad 902 may be closer to a keyboard of a computing device hosting the touchpad 902 and the rear edge 932 may be closer to a user of the computing device hosting the touchpad 902.

In one implementation, the touchpad 902 may include two force sensitive elements 910, such as piezo discs, located near two corners of the rear edge 932. Alternatively, the touchpad 902 may include one force sensitive element 920, such as a piezo disc, located near center of the rear edge 932. In yet another alternative implementation, the touchpad 902 may include more than two force sensitive elements 910 along the rear edge 932 of the touchpad 902. While the shape of the force sensitive elements 910, 920 is illustrated to be circular, in alternative implementations, the shape of the force sensitive elements 910, 920 may be of other geometry such as a square, a triangle, a rectangle, or other shape. In an alternative implementation, the force sensitive elements 910, 920 may be a combination of force sensitive elements and haptic elements, with the haptic elements providing vibrational feedback to the user.

The hinge mechanism 904 may be installed, along the z-direction, above the force sensitive elements and below a PCBA (such as PCBA 622 of FIG. 6) and a glass surface (such as glass surface 626 of FIG. 6). As a result, the hinge mechanism 904 is configured to mechanically mate the glass surface to the force sensitive elements 910. Thus for example, mechanical pressure exerted by a finger of a user on the glass surface may be transferred to the force sensitive elements 910, 920. In response the force sensitive elements 910, 920 may generate a signal that is processed by the PCBA.

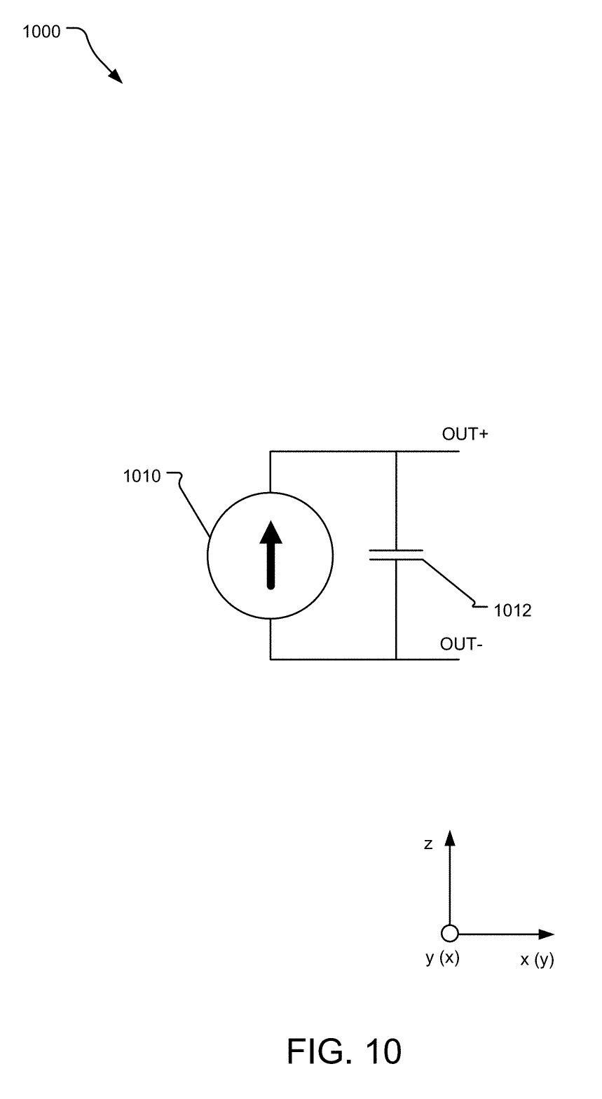

FIG. 10 illustrates an electrical model 1000 of an example haptic element used in the hinged touchpad disclosed herein. A haptic element, such as a piezo disc, maybe modeled as a current source 1010 in parallel with a capacitor 1012. As a force sensitive element receives mechanical force (such as pressure) along the z-direction, it may deflect along the z-direction. Such deflection generates a current that may be integrated onto the capacitor 1012 as a measurable voltage.

The voltage across the capacitor 1012 may be indicative of a signal provided by a user by providing pressure on the haptic element via, for example a glass surface and a PCBA installed on top of the haptic element. Thus, for example, when the capacitor 1012 is discharged, the measured voltage across the capacitor 1012 is zero—indicative of no pressure. When a user exerts pressure on the haptic element, the voltage across the capacitor may increase to, say one volt—indicating the pressure signal by the user. If the user holds the force, the current source 1010 discharges, resulting in zero voltage across the capacitor 1012 even when the user is holding the force (pressure) on the haptic element. Finally, when the user releases the force on the haptic element, the capacitor 1012 discharges through the current source 1010, resulting in the voltage of negative one volt across the capacitor 1012. Thus voltage signals across the capacitor 1012 may be interpreted as signals by a user.

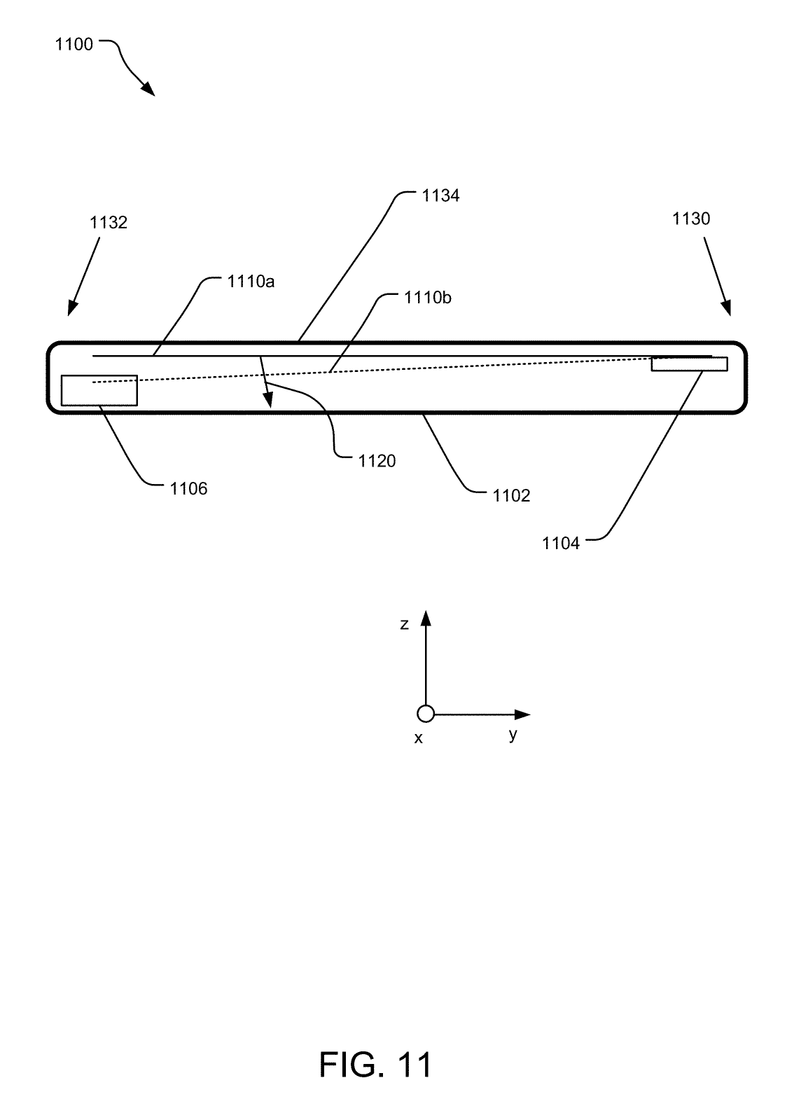

FIG. 11 illustrates a side view 1100 of an example hinged touchpad 1102 disclosed herein. The hinged touchpad 1102 includes a hinge mechanism 1104 located substantially near a front edge 1130 of the touchpad 1102 and one or more force sensitive elements 1106 located substantially near a rear edge 1132 of the touchpad. An assembly 1110 of glass surface, adhesive surface, and a PCBA may be installed on top of the hinge mechanism 1104 such that when pressure is applied to a top surface 1134 of the touchpad 1102, the assembly deflects as shown by arrow 1120 along z-direction. Such deflection 1120 may generate pressure on the force sensitive elements 1106, resulting in generation of a signal that may be processed by the PCBA or other components of a computing device hosting the touchpad 1102.

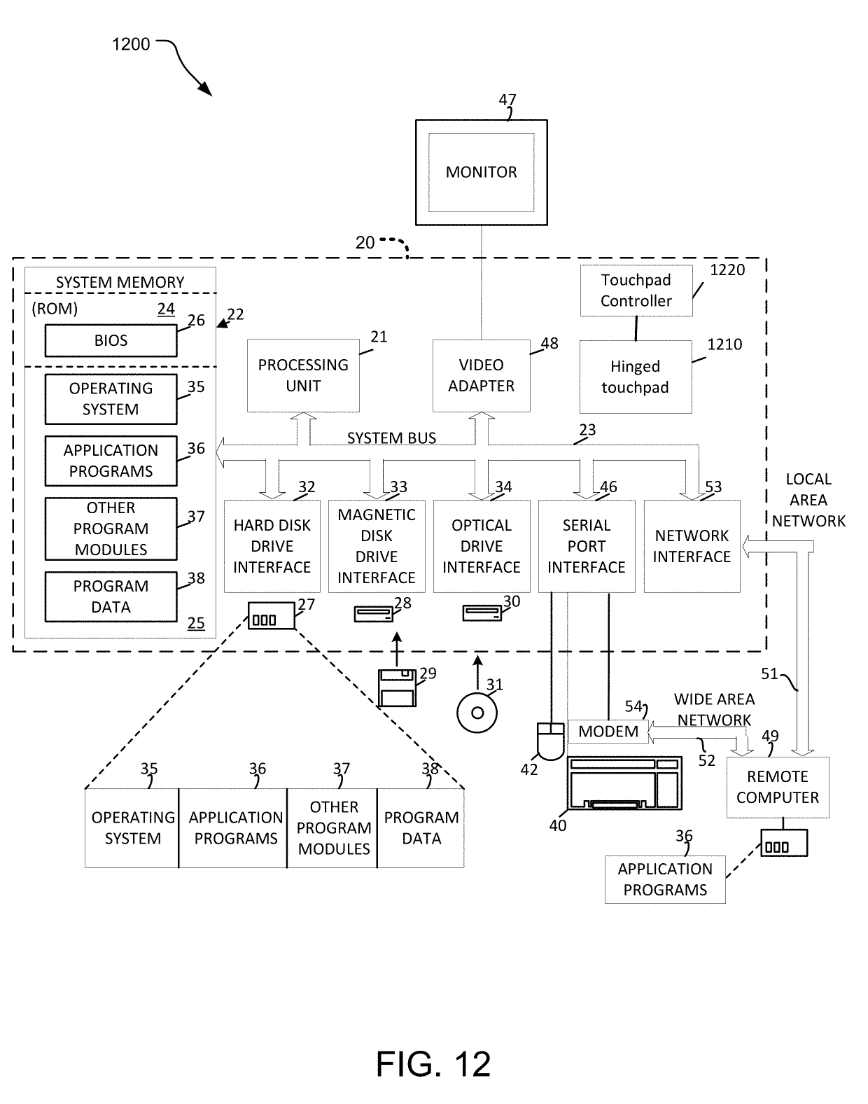

FIG. 12 illustrates an example system 1200 that may be useful in implementing the hinged touchpad disclosed herein. The example hardware and operating environment of FIG. 12 for implementing the described technology includes a computing device, such as a general purpose computing device in the form of a computer 20, a mobile telephone, a personal data assistant (PDA), a tablet, smart watch, gaming remote, or other type of computing device. In the implementation of FIG. 12, for example, the computer 20 includes a processing unit 21, a system memory 22, and a system bus 23 that operatively couples various system components including the system memory 22 to the processing unit 21. There may be only one or there may be more than one processing unit 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 1200, the computer 20 also includes a hinged touchpad 1210 such as a hinged touchpad disclosed herein. The hinged touchpad 1210 may communicate with touchpad controller 1220 to interpret the signal generated by the hinged touchpad 1210.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read-only memory (ROM) 24 and random access memory (RAM). A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a touchpad as disclosed herein. In one implementation, one or more instructions to interpret signal outputs generated by the hinged touchpad 1210 may be stored in the memory of the computer 20, such as the read-only memory (ROM) 24 and random access memory (RAM) 25, etc.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 12 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software or firmware instructions for the hinged touchpad 1210 may be stored in system memory 22 and/or storage devices 29 or 31 and processed by the processing unit 21. Hinged touchpad output and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some implementations of the hinged touchpad system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The hinged touchpad system disclosed herein may include a variety of tangible computer-readable storage media and intangible computer-readable communication signals. Tangible computer-readable storage can be embodied by any available media that can be accessed by the hinged touchpad system disclosed herein and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the hinged touchpad system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

An apparatus for a computing device disclosed herein comprises a touchpad configured to receive a force input from a user, a hinge mechanism along a front edge of the touchpad, and one or more force sensitive elements along a rear edge of the touchpad, the one or more force sensitive elements configured to generate a signal in response to the force input. An implementation of the apparatus further comprises one or more haptic elements configured along with the one or more force sensitive elements, wherein the one or more haptic elements are configured to provide a haptic feedback to the user in response to the force input. In another implementation of the apparatus, the one or more force sensitive elements are one or more piezo discs.

In an alternative implementation of the apparatus the one or more force sensitive elements are two piezo discs located substantially at two corners along the rear edge of the touchpad. Alternatively, the one or more force sensitive elements is one piezo disc located substantially at center the rear edge of the touchpad. Yet alternatively, the apparatus further comprises one or more retention plates of Mylar to hold the one or more force sensitive elements into a base. In an alternative implementation, the apparatus further comprises a printed circuit board assembly (PCBA) configured on top of the hinge mechanism, wherein the PCBA includes capacitive sensor for tracking finger movement by a user. In another implementation, the touchpad comprises a glass surface configured on top of the PCBA and a glass adhesive surface configured between the PCBA and the glass surface. In one alternative implementation, the apparatus further comprises a haptic element configured on the PCBA, the haptic element configured to provide a vibrational feedback to the user in response to the force input.

Further disclosed herein is an apparatus comprising a touchpad configured to receive a force input from a user, a hinge mechanism along a front edge of the touchpad, and one or more haptic elements along a rear edge of the touchpad, the one or more haptic elements configured to provide a haptic feedback to the user in response to the force input. In an alternative implementation, the one ore more haptic elements are piezo elements. In another implementation, the hinge mechanism is made of a sheet of fiberglass reinforced plastic. In one implementation, a partial upper edge of the hinge mechanism is attachably connected to a base configured to house the one or more haptic elements.

In one implementation of the apparatus, the one ore more haptic elements comprise two piezo elements located substantially near two rear corners of the touchpad. Alternatively, the one ore more haptic elements comprise one piezo element located substantially near center of the rear edge of the touchpad. In one implementation, the apparatus further comprises a PCBA configured on top of the hinge mechanism, wherein the PCBA includes capacitive sensor for tracking finger movement by a user on a glass surface configured on the PCBA.

A touchpad disclosed herein comprises one or more combinations of force sensitive elements and haptic elements along a rear edge of the touchpad and a hinge mechanism along a front edge of the touchpad. In one implementation of the touchpad, the one or more combinations of force sensitive elements and haptic elements are one or more piezo discs. In an alternative implementation of the touchpad, the one or more combinations of force sensitive elements and haptic elements are two piezo discs located substantially at two corners along the rear edge of the touchpad.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. An apparatus for a computing device, the apparatus comprising:
a touchpad configured to receive a force input;
a hinge mechanism along a front edge of the touchpad; and
one or more force sensitive elements along a rear edge of the touchpad, the one or more force sensitive elements configured to generate a signal in response to the force input.

2. The apparatus of claim 1, further comprising one or more haptic elements configured along with the one or more force sensitive elements, wherein the one or more haptic elements are configured to provide a haptic feedback in response to the force input.

3. The apparatus of claim 1, wherein the one or more force sensitive elements are one or more piezo discs.

4. The apparatus of claim 1, wherein the one or more force sensitive elements are two piezo discs located substantially at two corners along the rear edge of the touchpad.

5. The apparatus of claim 1, wherein the one or more force sensitive elements is one piezo disc located substantially at center the rear edge of the touchpad.

6. The apparatus of claim 5, further comprising one or more retention plates of Mylar to hold the one or more force sensitive elements into a base.

7. The apparatus of claim 1, further comprising a printed circuit board assembly (PCBA) configured on top of the hinge mechanism, wherein the PCBA includes capacitive sensor for tracking finger movement.

8. The apparatus of claim 7, wherein the touchpad comprises a glass surface configured on top of the PCBA.

9. The apparatus of claim 8, further comprising a glass adhesive surface configured between the PCBA and the glass surface.

10. The apparatus of claim 8, further comprising a haptic element configured on the PCBA, the haptic element configured to provide a vibrational feedback in response to the force input.

11. An apparatus, comprising:
a touchpad configured to receive a force input;
a hinge mechanism along a front edge of the touchpad; and
one or more haptic elements along a rear edge of the touchpad, the one or more haptic elements configured to provide a haptic feedback in response to the force input.

12. The apparatus of claim 11, wherein the one ore more haptic elements are piezo elements.

13. The apparatus of claim 11, wherein the hinge mechanism is made of a sheet of fiberglass reinforced plastic.

14. The apparatus of claim 13, wherein a partial upper edge of the hinge mechanism is attachably connected to a base configured to house the one or more haptic elements.

15. The apparatus of claim 11, wherein the one ore more haptic elements comprise two piezo elements located substantially near two rear corners of the touchpad.

16. The apparatus of claim 11, wherein the one ore more haptic elements comprises one piezo element located substantially near center of the rear edge of the touchpad.

17. The apparatus of claim 11, further comprising a PCBA configured on top of the hinge mechanism, wherein the PCBA includes capacitive sensor for tracking finger movement on a glass surface configured on the PCBA.

18. A touchpad, comprising:
one or more combinations of force sensitive elements and haptic elements along a rear edge of the touchpad; and
a hinge mechanism along a front edge of the touchpad.

19. The touchpad of claim 18, wherein the one or more combinations of force sensitive elements and haptic elements are one or more piezo discs.

20. The touchpad of claim 18, wherein the one or more combinations of force sensitive elements and haptic elements are two piezo discs located substantially at two corners along the rear edge of the touchpad.
